(19) United States
(12) Patent Application Publication
(10) Pub. No.: US 2018/0093854 A1
(43) Pub. Date: Apr. 5, 2018

(54) OCCUPANT EVACUATION OPERATION DISPLAY

(71) Applicant: Otis Elevator Company, Farmington, CT (US)

(72) Inventors: Ronnie E. Thebeau, Haddam, CT (US); Paul A. Stranieri, Bristol, CT (US); James M. Collins, Burlington, CT (US); Jannah A. Stanley, Portland, CT (US); David M. Hughes, East Hampton, CT (US)

(21) Appl. No.: 15/281,511

(22) Filed: Sep. 30, 2016

(51) Int. Cl. B66B 3/00; B66B 1/24; B66B 5/02

(52) U.S. Cl. CPC B66B 3/002; B66B 9/00; B66B 5/021; B66B 1/2408

(57) ABSTRACT

A building elevator system including: a building having multiple floors; an elevator system within the building, the elevator system having at least one elevator car; a display located on each floor proximate the elevator system, wherein the display is configured to illuminate evacuation information including an estimated time of arrival of the elevator car and an elevator status; and a control system configured to control the building elevator system and determine the evacuation information to illuminate for each display in response to at least one of a location of the elevator car in the building, a floor location of the display, a speed of the elevator car, a remaining capacity of the elevator car, a number of passengers on each floor, and an evacuation priority of the floor.

### BACKGROUND

The subject matter disclosed herein relates generally to the field of elevator systems, and specifically to a method and apparatus for operating an elevator system in a building evacuation.

Commonly, during an evacuation procedure occupants of a building are instructed to take the stairs and avoid the elevator systems. An efficient method of incorporating the elevators in to the overall evacuation procedures is desired.

### BRIEF SUMMARY

According to one embodiment, a building elevator system is provided. The building elevator system including: a building having multiple floors; an elevator system within the building, the elevator system having at least one elevator car; a display located on each floor proximate the elevator system, wherein the display is configured to illuminate evacuation information including an estimated time of arrival of the elevator car and an elevator status; and a control system configured to control the building elevator system and determine the evacuation information to illuminate for each display in response to at least one of a location of the elevator car in the building, a floor location of the display, a speed of the elevator car, a remaining capacity of the elevator car, a number of passengers on each floor, and an evacuation priority of the floor.

In addition to one or more of the features described above, or as an alternative, further embodiments the building elevator system may include that the display displays the estimated time of arrival of the elevator car by illuminating digital numbers.

In addition to one or more of the features described above, or as an alternative, further embodiments the building elevator system may include that the display displays the estimated time of arrival of the elevator car by illuminating a status indicator light adjacent to a fixed estimated time of arrival.

In addition to one or more of the features described above, or as an alternative, further embodiments the building elevator system may include that the display displays the estimated time of arrival of the elevator car by illuminating a fixed estimated time of arrival.

In addition to one or more of the features described above, or as an alternative, further embodiments the building elevator system may include that the display displays the elevator status by illuminating a status indicator light adjacent to a fixed elevator status.

In addition to one or more of the features described above, or as an alternative, further embodiments the building elevator system may include that the display displays the elevator status by illuminating a fixed elevator status.

According to another embodiment, a method of operating a building elevator system for a building having multiple floors is provided. The method includes: controlling, using a control system, an elevator system, the elevator system including at least one elevator car; receiving, using the control system, an evacuation call; determining, using the control system, evacuation information; and displaying, using a plurality of displays, evacuation information, wherein a display is located on each floor proximate the elevator system; wherein the control system determines the evacuation information in response to at least one of a location of the elevator car in the building, a floor location of the display, a speed of the elevator car, a remaining capacity of the elevator car, a number of passengers on each floor, and an evacuation priority of the floor.

In addition to one or more of the features described above, or as an alternative, further embodiments the method may include that the display displays the estimated time of arrival of the elevator car by illuminating digital numbers.

In addition to one or more of the features described above, or as an alternative, further embodiments the method may include that the display displays the estimated time of arrival of the elevator car by illuminating a status indicator light adjacent to a fixed estimated time of arrival.

In addition to one or more of the features described above, or as an alternative, further embodiments the method may include that the display displays the estimated time of arrival of the elevator car by illuminating a fixed estimated time of arrival.

In addition to one or more of the features described above, or as an alternative, further embodiments the method may include that the display displays the elevator status by illuminating a status indicator light adjacent to a fixed elevator status.

In addition to one or more of the features described above, or as an alternative, further embodiments the method may include that the display displays the elevator status by illuminating a fixed elevator status.

According to another embodiment, a computer program product tangibly embodied on a computer readable medium is provided. The computer program product including instructions that, when executed by a processor, cause the processor to perform operations. The operations including the steps of: controlling, using a control system, an elevator system, the elevator system including at least one elevator car; receiving, using the control system, an evacuation call; determining, using the control system, evacuation information; and displaying, using a plurality of displays, evacuation information, wherein a display is located on each floor proximate the elevator system; wherein the control system determines the evacuation information in response to at least one of a location of the elevator car in the building, a floor location of the display, a speed of the elevator car, a remaining capacity of the elevator car, a number of passengers on each floor, and an evacuation priority of the floor.

In addition to one or more of the features described above, or as an alternative, further embodiments the computer program may include that the display displays the estimated time of arrival of the elevator car by illuminating digital numbers.

In addition to one or more of the features described above, or as an alternative, further embodiments the computer program may include that the display displays the estimated time of arrival of the elevator car by illuminating a status indicator light adjacent to a fixed estimated time of arrival.

In addition to one or more of the features described above, or as an alternative, further embodiments the computer program may include that the display displays the estimated time of arrival of the elevator car by illuminating a fixed estimated time of arrival.

In addition to one or more of the features described above, or as an alternative, further embodiments the computer program may include that the display displays the elevator status by illuminating a status indicator light adjacent to a fixed elevator status.

In addition to one or more of the features described above, or as an alternative, further embodiments the computer program may include that the display displays the elevator status by illuminating a fixed elevator status.

Technical effects of embodiments of the present disclosure include an elevator system having a display located on each floor displaying, through illumination of lights, evacuation information including the estimated arrival time of the next elevator car and an elevator status.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the disclosure are apparent from the following detailed description taken in conjunction with the accompanying drawings in which like elements are numbered alike in the several FIGURES:

FIG. 1 illustrates a schematic view of an elevator system, in accordance with an embodiment of the disclosure;

FIG. 2 illustrates a schematic view of a building elevator system incorporating the elevator system of FIG. 1, in accordance with an embodiment of the disclosure;

FIG. 3 illustrates a schematic view of a display for use in the building elevator system of FIG. 2, in accordance with an embodiment of the disclosure;

FIG. 4 illustrates a schematic view of a display for use in the building elevator system of FIG. 2, in accordance with an embodiment of the disclosure; and

FIG. 5 is a flow chart of method of operating the building elevator system of FIG. 2, in accordance with an embodiment of the disclosure.

### DETAILED DESCRIPTION

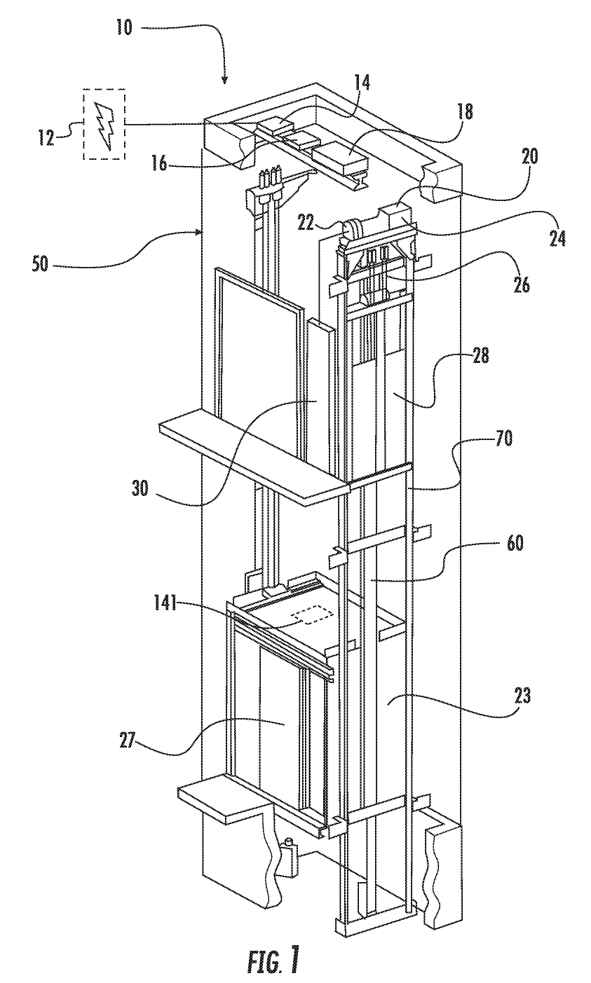

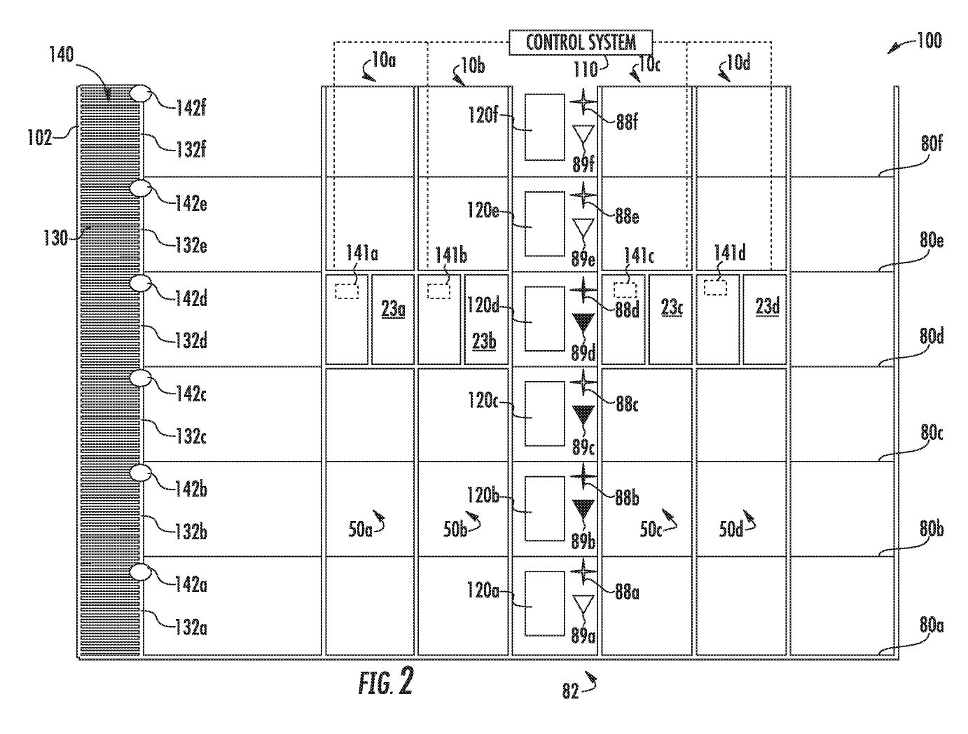

FIG. 1 illustrates a schematic view of an elevator system 10, in accordance with an embodiment of the disclosure. FIG. 2 illustrates a schematic view of a building elevator system 100 incorporating the elevator system 10 of FIG. 1, in accordance with an embodiment of the disclosure. With reference to FIG. 1, the elevator system 10 includes an elevator car 23 configured to move vertically upward and downward within a hoistway 50 along a plurality of car guide rails 60. As seen in FIG. 1, the elevator car 23 includes a door 27 configured to open and close, allowing passengers (ex: occupants of the building 102) to enter and exit the elevator car 23. The elevator system 10 also includes a counterweight 28 operably connected to the elevator car 23 via a pulley system 26. The counterweight 28 is configured to move vertically upward and downward within the hoistway 50. The counterweight 28 moves in a direction generally opposite the movement of the elevator car 23, as is known in conventional elevator assemblies. Movement of the counterweight 28 is guided by counterweight guide rails 70 mounted within the hoistway 50.

The elevator system 10 also includes a power source 12. The power is provided from the power source 12 to a switch panel 14, which may include circuit breakers, meters, etc. From the switch panel 14, the power may be provided directly to the drive unit 20 through the controller 30 or to an internal power source charger 16, which converts AC power to direct current (DC) power to charge an internal power source 18 that requires charging. For instance, an internal power source 18 that requires charging may be a battery, capacitor, or any other type of power storage device known to one of ordinary skill in the art. Alternatively, the internal power source 18 may not require charging from the external power source 12 and may be a device such as, for example a gas powered generator, solar cells, hydroelectric generator, wind turbine generator or similar power generation device. The internal power source 18 may power various components of the elevator system 10 when an external power source is unavailable. The drive unit 20 drives a machine 22 to impart motion to the elevator car 23 via a traction sheave of the machine 22. The machine 22 also includes a brake 24 that can be activated to stop the machine 22 and elevator car 23. As will be appreciated by those of skill in the art, FIG. 1 depicts a machine room-less elevator system 10, however the embodiments disclosed herein may be incorporated with other elevator systems that are not machine room-less or that include any other known elevator configuration. In addition, elevator systems having more than one independently operating elevator car in each elevator car shaft and/or ropeless elevator systems may also be used. In one embodiment, the elevator car 23 may have two or more compartments.

The controller 30 is responsible for controlling the operation of the elevator system 10. The controller 30 may also determine a mode (motoring, regenerative, near balance) of the elevator car 23. The controller 30 may use the car direction and the weight distribution between the elevator car 23 and the counterweight 28 to determine the mode of the elevator car 23. The controller 30 may adjust the velocity of the elevator car 23 to reach a target floor. The controller 30 may include a processor and an associated memory. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

The elevator system 10 may also include a sensor system 141 configured to detect a remaining capacity in a particular elevator car 23. The remaining capacity allows the controller 30 to determine how much space is left in the elevator car 23. For instance, if the remaining capacity is equal to about zero there is no space left in the elevator car 23 to accept more passengers, whereas if the remaining capacity is greater than zero there may be space to accept more passengers in the elevator car 23. The sensor system 141 is in operative communication with the controller 30. The sensor system 141 may use a variety of sensing mechanisms such as, for example, a visual detection device, a weight detection device, a laser detection device, a door reversal monitoring device, a thermal image detection device, and a depth detection device. The visual detection device may be a camera that utilizes visual recognition to identify individual passengers and objects in the elevator car 23 and then determine remaining capacity. The weight detection device may be a scale to sense the amount of weight in an elevator car 23 and then determine the remaining capacity from the weight sensed. The laser detection device may detect how many passengers walk through a laser beam to determine the remaining capacity in the elevator car 23. Similarly, a door reversal monitoring device also detects passengers entering the car so as not to close the elevator door on a passenger and thus may be used to determine the remaining capacity. The thermal detection device may be an infrared or other heat sensing camera that utilizes detected temperature to identify individual passengers and objects in the elevator car 23 and then determine remaining capacity. The depth detection device may be a 2-D, 3-D or other depth/distance detecting camera that utilizes detected distance to an object and/or passenger to determine remaining capacity. As may be appreciated by one of skill in the art, in addition to the stated methods, additional methods may exist to sense remaining capacity and one or any combination of these methods may be used to determine remaining capacity in the elevator car 23.

FIG. 2 shows a building elevator system 100 incorporating a multiple elevator systems 10a-10d organized in an elevator bank 82 within a building 102. As may be appreciated by one of skill in the art, FIG. 2 only shows one elevator bank 82 for simplicity but more than one elevator banks may exist in the building 102. Each elevator system 10a-10d has an elevator car 23a-23d. The building elevator system 100 is controlled by a system controller 110. The control system 110 is operably connected to the individual controller 30 (see FIG. 1) of each elevator system 10a-10d. The control system 110 is configured to the control and coordinate operation of multiple elevator systems 10a-10d. In one embodiment, each elevator system 10a-10d may share a single controller 30. The control system 110 may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium

The building 102 includes multiple floors 80a-80f, each having an elevator call button 89a-89f and an evacuation alarm 88a-88f. The elevator call button 89a-89f may be a push button and/or a touch screen and may be activated manually or automatically. For example, the elevator call button 89a-89f may be activated by a building occupant pushing the elevator call button 89a-89f. The elevator call button 89a-89f may also be activated voice recognition or a passenger detection mechanism in the hallway, such as, for example a weight sensing device, a visual recognition device, and a laser detection device. The elevator call button 89a-89f sends an elevator call to the control system 110. The evacuation alarm 88a-88f may be activated or deactivated either manually or through an automated alarm system, such as, for example a fire alarm and smoke alarm. If the evacuation alarm 88a-88f is activated, an evacuation call is sent to the control system 110 indicating the respective floor 80a-80f where the evacuation alarm 88a-88f was activated. In the example of FIG. 2, an evacuation alarm 88d is activated first on floor 80d and an evacuation alarm 88b is later activated on floor 80b. The evacuation alarm 88a, 88, 88e, 88f not activated on floors 80a, 80c, 80e, and 80f. The first floor to activate an evacuation alarm may be known as the first evacuation floor. In the example of FIG. 2, the first evacuation floor is floor 80d. The second evacuation floor to activate an evacuation alarm may be known as the second evacuation floor and so on.

The first evacuation floor may be surrounded by padding floors, which are floors that are considered at increased risk due to their proximity to the evacuation floor and thus should also be evacuated. In the example of FIG. 2, the padding floors for the first evacuation floor are floors 80b, 80c, 80e, and 80f. The padding floors may include floors that are a selected number of floors away from the first evacuation floor. In one embodiment, the padding floors may include any number of floors on either side of an evacuation floor. For example, in one embodiment, the padding floors may include the floor immediately below the evacuation floor and the three floors immediately above the evacuation floor. In another example, in one embodiment, the padding floors may include the two floors immediately below the evacuation floor and the two floors immediately above the evacuation floor. The first evacuation floor and the padding floors make up an evacuation zone 83. In the example of FIG. 2, the evacuation zone is composed of floors 80b-80f. In an example, the control system 110 may prioritize the first evacuation floor for evacuation, the evacuation zone 83 for evacuation and/or higher floors for evacuation over lower floors.

In one embodiment, there may be more than one evacuation floor. For example, after the first evacuation floor activates an evacuation alarm, a second evacuation floor may also activate an evacuation alarm. In the example of FIG. 2, the second evacuation floor is floor 80b. In one embodiment, there may be any number of evacuation floors. Evacuation floors may be evacuated in the order that the evacuation call is received. Padding floors of the first evacuation floor may be evacuated before the second evacuation floor. In one embodiment, all evacuation floors may be evacuated first, followed by padding floors associated with each evacuation floor in the order in which the corresponding evacuation call was placed. Although in the embodiment of FIG. 2 the second evacuation floor is contiguous to the padding floors of the first evacuation floor, the second evacuation floor and any subsequent evacuation floors may be located anywhere within the building. The building also includes a discharge floor, which is a floor where occupants can evacuate the building 102. For example, in one embodiment the discharge floor may be a ground floor. In another embodiment, the discharge floor may be any floor in the building from which escape or other form of safety is available. In the example of FIG. 2, the discharge floor is floor 80a. The building may also include a stairwell 130 as seen in FIG. 2.

The control system 110 may be configured to determine how many passengers are on a particular floor 80a-80f. The control system 110 may determine how many passengers are on a particular floor 80a-80f using an executable algorithm and/or a look up table that may be stored within the memory of the controller 30. The look up table may contain predicted number for how many passengers are on each floor 80a-80f on a particular date at a particular time. For example, the predicted number of passenger may be more for a day during the work week than a day on the weekend. In one embodiment, this data may be provided into the system by a building manager, tenants, or businesses located in the building 102. For example, the data could include a number of employees employed at a business on a particular floor of the building 102 and the expected working hours and days of those employees. In one embodiment, expected working hours and days could be entered for each employee. The data may be input when the system is first commissioned or updated at periodic intervals as desired.

The control system 110 may also determine how many passengers are on a particular floor 80a-80f using a building integrated personnel sensing system 140 composed a plurality of sensors throughout the building 102 configured to detect a number of passengers on each floor 80a-80f. The building integrated personnel sensing system 140 may count the number of passengers entering and exiting each floor 80a-80f using stairwell door sensors 142a-142f and also the sensor systems 141a-141d in each elevator car 23a-23d. In one embodiment, the number of personnel on a particular floor may be determined by using security access control data (and corresponding floor access permissions/information) as personnel scan their credentials as they enter the building.

The stairwell door sensor 142a-142f counts the number of passengers entering and exiting the respective stairwell door 132a-132f. The stairwell door sensor 142a-142f may use a variety of sensing mechanisms such as, for example, a visual detection device, a weight detection device, a laser detection device, a thermal image detection device, and a depth detection device. The visual detection device may be a camera that utilizes visual recognition to identify and count individual passengers entering and exiting a particular floor 80a-80f from the stairwell 130. The weight detection device may be a scale to sense the amount of weight in an area proximate the stairwell door 132a-132f and then determine the number of passengers entering and exiting a particular floor 80a-80f from the weight sensed. The laser detection device may detect how many passengers walk through a laser beam located proximate the stairwell door 132a-132f to determine the number of passengers entering and exiting a floor 80a-80f. The thermal detection device may be an infrared or other heat sensing camera that utilizes detected temperature to identify how many passengers are located proximate the stairwell door 132a-132f to determine the number of passengers entering and exiting a floor 80a-80f. The depth detection device may be a 2-D, 3-D or other depth/distance detecting camera that utilizes detected distance to a passenger to determine how many passengers are located proximate the stairwell door 132a-132f to determine the number of passengers entering and exiting a floor 80a-80f. The stairwell door sensor 142a-142f interacts with the sensor systems 141a, 141b to determine the number of passengers on each floor 80a-80f. As may be appreciated by one of skill in the art, in addition to the stated methods, additional methods may exist to sense passengers and one or any combination of these methods may be used to determine the number of passengers entering and exiting a floor 80a-80f.

Advantageously, in one embodiment, by tracking the number of passengers entering or exiting a floor 80a-80f, when an evacuation call is received from a first evacuation floor, the controller 30 could quickly identify the floors 80a-80f with the most passengers and allocate elevator cars 23a-23d accordingly.

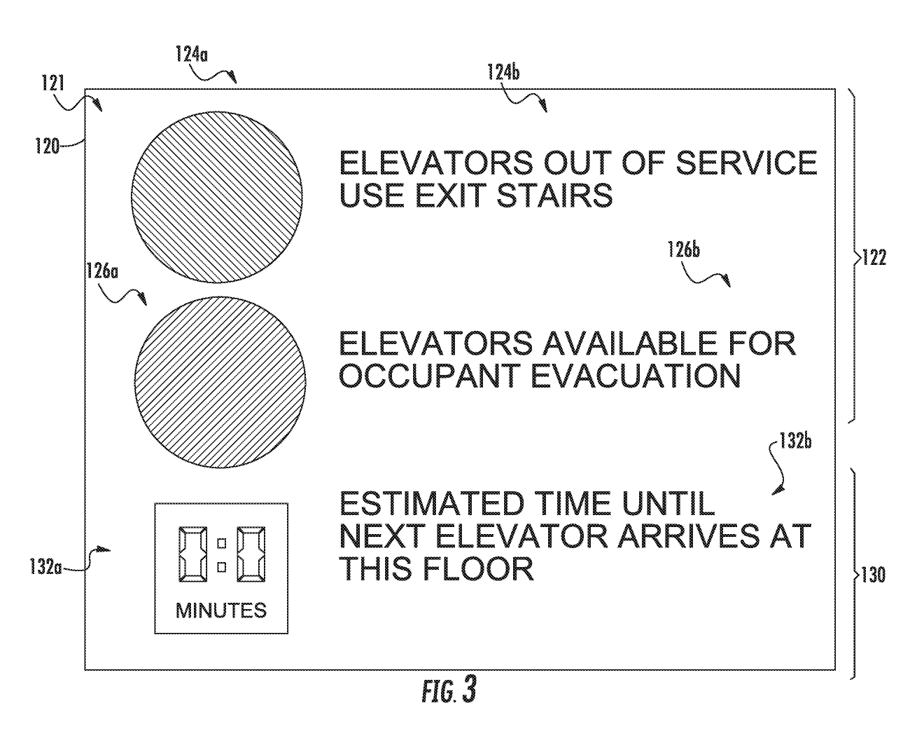

As seen in FIG. 2, each elevator bank 92, 94 includes a display 120a-120f on each floor 80a-80f. The displays 120a-120f are located proximate to the elevator systems 10a-10d on each floor 80a-80f. The control system 110 may determine the evacuation information 121 (FIG. 3) to illuminate for each display 120a-120f in response at least one of the location of the elevator car 23a-23d in the building 102, the location of the display 120a-120f, the speed of the elevator car 23a-23d, the remaining capacity of the elevator car 23a-23d, and an evacuation priority of the floor. The location of the elevator car 23a-23d may affect what is displayed because the display 120a-120f may be associated with some subset of elevator cars and therefore only display information pertinent to that specific subset of elevator cars. The location of the elevator car 23a-23d or more specifically, the location of the elevator car 23a-23d in the respective elevator hoistway 50a-50d may affect the estimated time of arrival 130 of the elevator car 23a-23d to a particular floor. The speed of the elevator car 23a-23d may affect the estimated time of arrival 130 that is displayed. The remaining capacity of the car 23a-23d may affect the estimated time of arrival 130 that is displayed. The evacuation priority may be used to help determine the estimated time of arrival 130 of the elevator cars 23a-23d to a particular floor. The higher the floor priority the lower the estimated time of arrival 130 for the elevator cars 23a-23d. The lower the priority the higher the estimated time of arrival 130 for the elevator cars 23a-23d. As mentioned above, the control system 110 may prioritize the first evacuation floor for evacuation, the evacuation zone 83 for evacuation and/or higher floors for evacuation over lower floors for an evacuation.

Referring to FIG. 3, the display 120 displays evacuation information 121 including an estimated time of arrival 130 of the elevator car 23 and an elevator status 122. The display 120 may be a combination of illuminated lights 124a, 126a, 132a and/or a fixed elevator status 124b, 126b, 132b. The term fixed may indicate that the wording does not change, such as, for example written, painted, sculpted, inscribed, etched, or any other method know to one of skill in the art. The illuminated lights 124a, 126a, 132a may be adjacent to and associated with the fixed elevator status 124b, 126b, 132b and/or the fixed elevator status 124b, 126b, 132b may be translucent and illuminate itself. As seen in FIG. 3, the display includes a first fixed elevator status 124b along with an adjacent first status indicator light 124a configured to illuminate as determined by the control system 110. As seen in FIG. 3, the first fixed elevator status 124b may state “Elevator out of service Use exit stairs”. For example, the control system 110 will illuminate the light 124a when the control system 110 determines that the passenger should take the stairwell 130 instead of the elevator cars 23a-23d.

The display 120 may include a second fixed elevator status 126b indicating “Elevators available for Occupant evacuation” along with an adjacent second status indicator light 126a. The second status indicator light 126a is configured to illuminate as determined by the control system 110. For example, the second status indicator light 126a may illuminate when the control system 110 determines that the elevator cars 23a-23d may be used for evacuation. In an embodiment the fixed elevator status 124b, 126b may also be translucent and illuminate as determined by the control system 110. As seen in FIG. 3, the estimated time of arrival 130 may be displayed by illuminating digital numbers 132a. Proximate the digital numbers 132a may be a fixed message 132b indicating the meaning of the digital numbers 132a. In the example of FIG. 3, the fixed message 132 proximate the digital numbers 132a may state, “Estimated time until next elevator arrives at this floor”. The digital numbers 132a of estimated time of arrival 130 may be updated at a selected time interval, such as, for example every 30 seconds. In one embodiment, the digital numbers 132a of estimated time of arrival 130 may be updated in real time and/or continuously. In one embodiment, the digital numbers 132a of estimated time of arrival 130 may be updated at intervals greater than or less than 30 seconds.

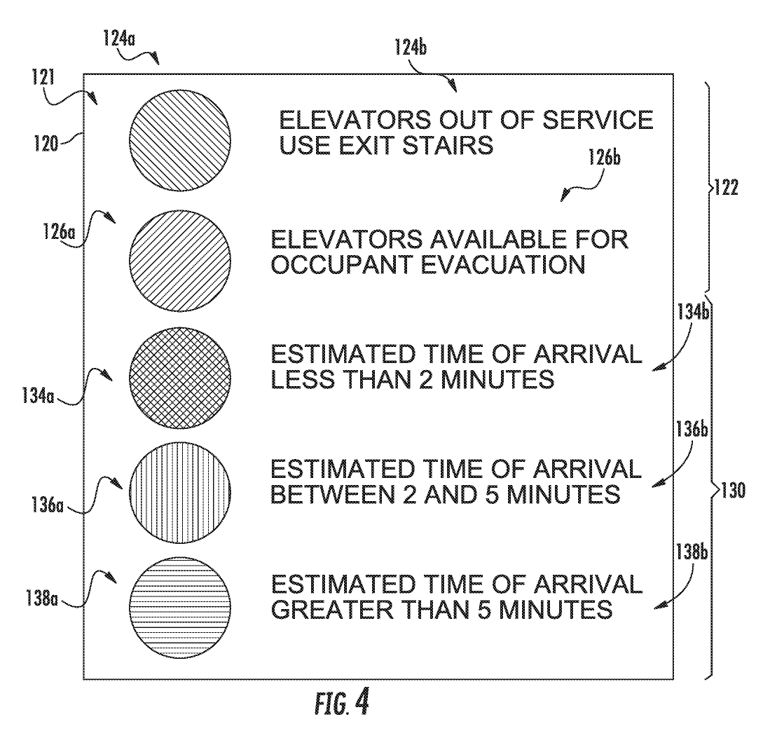

Referring to FIG. 4, the display 120 displays evacuation information 121 including an estimated time of arrival 130 of the elevator car 23 and an elevator status 122. The display 120 may be a combination of illuminated lights 124a, 126a, 134a, 136a, 138a and/or fixed elevator status 124b, 126b, 134b, 136b, 138b. The illuminated lights 124a, 126a, 134a, 136a, 138a may be adjacent to and associated with the fixed elevator status 124b, 126b, 134b, 136b, 138b and/or the fixed elevator status 124b, 126b, 134b, 136b, 138b may be translucent and illuminate itself.

As seen in FIG. 4, the display includes a first fixed elevator status 124b along with an adjacent first status indicator light 124a configured to illuminate as determined by the control system 110. As seen in FIG. 4, the first fixed elevator status 124b may state “Elevator out of service Use exit stairs”. For example, the control system 110 will illuminate the light 124a when the control system 110 determines that the passenger should take the stairwell 130 instead of the elevator cars 23a-23d. The display 120 may include a second fixed elevator status 126b indicating “Elevators available for Occupant evacuation” along with an adjacent second status indicator light 126a. The second status indicator light 126a is configured to illuminate as determined by the control system 110. For example, the second status indicator light 126a may illuminate when the control system 110 determines that the elevator cars 23a-23d may be used for evacuation. In an embodiment the fixed elevator status 124b, 126b may also be translucent and illuminate as determined by the control system 110.

As seen in FIG. 4, the estimated time of arrival 130 may be displayed by illuminating status indicator lights 134a, 136a, 138a, adjacent to a fixed estimated time of arrivals 134b, 136b, 138. In the example of FIG. 4, there are three fixed estimated time of arrivals 134b, 136b, 138b. The first fixed estimated time of arrival 134b adjacent to the third status indicator light 134a may indicate that the elevator car 23 will arrive in less than a selected amount of time. In the example of FIG. 4, the first fixed estimated time of arrival 134b may state, “Estimated time of arrival Less than 2 minutes”. The third status indicator light 134a illuminates when the control system 110 determines that an elevator cars 23a-23d will arrive in less than the selected amount of time. The second fixed estimated time of arrival 136b adjacent to the fourth status indicator light 136a may indicate that the elevator car 23 will arrive in between a selected range of time. In the example of FIG. 4, the second fixed estimated time of arrival 136b may state, “Estimated time of arrival Between 2 and 5 minutes”. The fourth status indicator light 136a illuminates when the control system 110 determines that an elevator car 23a-23d will arrive in the selected range of time. The third fixed estimated time of arrival 138b adjacent to the fifth status indicator light 138a may indicate that the elevator car 23 will arrive after a selected amount of time. In the example of FIG. 4, the third fixed estimated time of arrival 138b may state, “Estimated time of arrival Greater than 5 minutes”. The fifth status indicator light 138a illuminates when the control system 110 determines that an elevator cars 23a-23d will arrive after a selected amount of time. In an embodiment, the fixed estimated time of arrivals 134b, 136b, 138b may also be translucent and illuminate as determined by the control system 110. In one embodiment, the estimated time of arrival 130 may listed out in any desired number of increments describing a desired estimated times of arrival. In one embodiment, any desired phrasing or language may be used to indicate the elevator status 122 and estimated time of arrival 130.

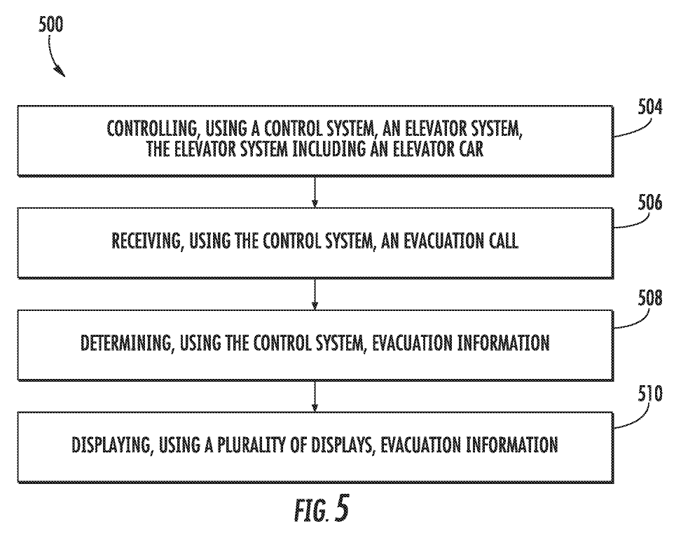

Referring now to FIG. 5, while referencing components of FIGS. 1-4. FIG. 5 shows a flow chart of method 500 of operating the building elevator system 100 of FIG. 2, in accordance with an embodiment of the disclosure. At block 504, the control system 110 controls the elevator system 10, which include an elevator car 23 as described above. At block 506, the control system 110 receives an evacuation call. Once the evacuation call is received, the control system 110 determines evacuation information 121 to send to the displays 120a-120f on each floor 80a-80f at block 508. As described above, evacuation information 121 may include an estimated time of arrival 130 of the elevator car 23 and an elevator status 122. At block 510, a display 120a-120f located on each floor 80a-80f will display evacuation information 120. The evacuation information 120 may be specific to each floor 80a-80f. The control system 110 determines the evacuation information 120 in response to at least one of a location of the elevator car 23 in the building 102, a floor location of the display 120, a speed of the elevator car 23, a remaining capacity of the elevator car 23, a number of passengers on each floor 80a-80f, and an evacuation priority of the floor. While the above description has described the flow process of FIG. 5 in a particular order, it should be appreciated that unless otherwise specifically required in the attached claims that the ordering of the steps may be varied.

As described above, embodiments can be in the form of processor-implemented processes and devices for practicing those processes, such as processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The terminology used herein is for the purpose of describing particular embodiments only and is not intended to be limiting. While the description has been presented for purposes of illustration and description, it is not intended to be exhaustive or limited to embodiments in the form disclosed. Many modifications, variations, alterations, substitutions or equivalent arrangement not hereto described will be apparent to those of ordinary skill in the art without departing from the scope of the disclosure. Additionally, while the various embodiments have been described, it is to be understood that aspects may include only some of the described embodiments. Accordingly, the disclosure is not to be seen as limited by the foregoing description, but is only limited by the scope of the appended claims.

1. A building elevator system comprising:
a building having multiple floors;
an elevator system within the building, the elevator system having an elevator car;
a display located on each floor proximate the elevator system, wherein the display is configured to illuminate evacuation information during an evacuation, the evacuation information including an estimated time of arrival of the elevator car and an elevator status that indicates whether the elevator car can be used for evacuation; and
a control system configured to control the building elevator system and determine the evacuation information to illuminate for each display in response to at least one of a location of the elevator car in the building, a floor location of the display, a speed of the elevator car, a remaining capacity of the elevator car, a number of passengers on each floor, and an evacuation priority of the floor.

2. The building elevator system of claim 1, wherein:
the display displays the estimated time of arrival of the elevator car by illuminating digital numbers.

3. The building elevator system of claim 1, wherein:
the display displays the estimated time of arrival of the elevator car by illuminating a status indicator light adjacent to a fixed estimated time of arrival.

4. The building elevator system of claim 1, wherein:
the display displays the estimated time of arrival of the elevator car by illuminating a fixed estimated time of arrival.

5. The building elevator system of claim 1, wherein:
the display displays the elevator status by illuminating a status indicator light adjacent to a fixed elevator status.

6. The building elevator system of claim 1, wherein:
the display displays the elevator status by illuminating a fixed elevator status.

7. A method of operating a building elevator system for a building having multiple floors, the method comprising:
controlling, using a control system, an elevator system, the elevator system including an elevator car;
receiving, using the control system, an evacuation call;
determining, using the control system, evacuation information; and
displaying, using a plurality of displays, evacuation information during an evacuation, the evacuation information including an estimated time of arrival of the elevator car and an elevator status that indicates whether the elevator car can be used for evacuation, wherein a display is located on each floor proximate the elevator system;
wherein the control system determines the evacuation information in response to at least one of a location of the elevator car in the building, a floor location of the display, a speed of the elevator car, a remaining capacity of the elevator car, a number of passengers on each floor, and an evacuation priority of the floor.

8. The method of claim 7, wherein:
the display displays the estimated time of arrival of the elevator car by illuminating digital numbers.

9. The method of claim 7, wherein:
the display displays the estimated time of arrival of the elevator car by illuminating a status indicator light adjacent to a fixed estimated time of arrival.

10. The method of claim 7, wherein:
the display displays the estimated time of arrival of the elevator car by illuminating a fixed estimated time of arrival.

11. The method of claim 7, wherein:
the display displays the elevator status by illuminating a status indicator light adjacent to a fixed elevator status.

12. The method of claim 7, wherein:
the display displays the elevator status by illuminating a fixed elevator status.

13. A computer program product tangibly embodied on a computer readable medium, the computer program product including instructions that, when executed by a processor, cause the processor to perform operations comprising:
controlling, using a control system, an elevator system, the elevator system including an elevator car;
receiving, using the control system, an evacuation call;
determining, using the control system, evacuation information; and
displaying, using a plurality of displays, evacuation information during an evacuation, the evacuation information including an estimated time of arrival of the elevator car and an elevator status that indicates whether the elevator car can be used for evacuation, wherein a display is located on at least one of a plurality of floors proximate the elevator system;
wherein the control system determines the evacuation information in response to at least one of a location of the elevator car in a building, a floor location of the display, a speed of the elevator car, a remaining capacity of the elevator car, a number of passengers on each floor, and an evacuation priority of the floor.

14. The computer program of claim 13, wherein:
the display displays the estimated time of arrival of the elevator car by illuminating digital numbers.

15. The computer program of claim 13, wherein:
the display displays the estimated time of arrival of the elevator car by illuminating a status indicator light adjacent to a fixed estimated time of arrival.

16. The computer program of claim 13, wherein:
the display displays the estimated time of arrival of the elevator car by illuminating a fixed estimated time of arrival.

17. The computer program of claim 13, wherein:
the display displays the elevator status by illuminating a status indicator light adjacent to a fixed elevator status.

18. The computer program of claim 13, wherein:
the display displays the elevator status by illuminating a fixed elevator status.
